(19) United States
(12) Patent Application Publication
(10) Pub. No.: US 2003/0008616 A1
(43) Pub. Date: Jan. 9, 2003

(54) Method and system for FM stereo broadcasting

(76) Inventor: Lelan S. Anderson, Beverly Hills, CA (US)

Correspondence Address: Squire, Sanders & Dempsey L.L.P., 14th Floor, 801 S. Figueroa Street, Los Angeles, CA, 90017-5554, US

(21) Appl. No.: 10/192,927

(22) Filed: Jul. 9, 2002

Related U.S. Application Data
(60) Provisional application No. 60/303,830, filed on Jul. 9, 2001.

(51) Int. Cl. H04B 1/00; H04B 7/00

(52) U.S. Cl. 455/45

(57) ABSTRACT

This invention provides a system capable of transmitting two different audio programs in one FM channel signal and generate either one of the audio programs through an FM receiver, such as an FM radio or stereo playback device using pre-recorded media. To accomplish this, one program may be transmitted through the left channel of the FM channel signal and a different program in the right channel of the FM channel signal. A switching circuit may be provided either internally or externally for an FM receiver, headset or speakers that can switch between the “left” and “right” audio programs in the FM channel signal so that a listener may select from either audio programs within one FM channel signal.

### BACKGROUND OF THE INVENTION

1. Related Applications

This application is a non-provisional application based on a provisional application having a serial no. 60/303,830, filed Jul. 9, 2001, which is hereby incorporated by reference.

2. Field of the Invention

This invention provides a system capable of broadcasting two separate audio programs to one Frequency Modulated (FM) channel and allows a listener to choose between the two separate audio programs from one FM channel.

3. General Background and State of the Art

Radio transmission was first developed with Amplitude Modulated (AM) broadcasting, where audio is conveyed from a radio frequency transmitter to a receiver by causing the amplitude of the radio frequency carrier to vary in accordance with an audio waveform. The AM broadcast band ranges from 540 Kilohertz to 1.6 Megahertz. Stations are assigned so that the minimum separation between carrier frequencies of adjacent stations is 10 Kilohertz. The FCC restricts AM broadcast transmissions to 5 Kilohertz so that the transmission does not exceed the 10 Kilohertz allocation and prevent interfering with adjacent stations.

Limiting AM broadcast transmission to 5 Kilohertz, however, results in relatively low fidelity audio sound. Electrical noise commonly manifests in AM broadcasts as well as rapid and irregular variations of the amplitude in the radio frequency carrier. Moreover, the relatively low 540 Kilohertz to 1.6 Megahertz frequency band for AM signals cannot effectively penetrate buildings and other barriers through which higher frequencies can pass.

The problems associated with AM broadcast have been largely overcome with the arrival of frequency modulation (FM) broadcasting. In Frequency Modulation, the carrier wave deviates in frequency a small range in accordance with the audio signal. Frequency Modulated radio transmissions are much more immune to noise, primarily because FM demodulators respond to variations in frequency rather than amplitude. As a result, FM transmissions are virtually free of noise as compared with AM transmissions. The FM broadcast band ranges from 88 to 108 Megahertz, and stations are located in 200 Kilohertz intervals. The higher frequency range allows the FM signal to effectively penetrate many types of barriers that an AM signal could not. Moreover, the wider FM bandwidth is what accounts for the higher fidelity of FM transmissions as compared with AM.

The 200 Kilohertz bandwidth in an FM channel is sufficient to transmit two independent high fidelity channels. For example, FM stereo system is an enhancement of the original FM monaural system, where one audio program is split into two audio signals and transmitted through two channels in one FM radio frequency carrier. The two audio signals may be considered as Left and Right audio signals that are received by a FM radio, and fed to a left and right speakers, respectively. And because the Left and Right audio signals are synchronized for one audio program, the sound from left and right speakers generate a coherent audio program that is understood by a listener. For example, the “Left” channel may contain vocal signal for a song and the “Right” channel may contain background instrumental synchronized with the vocal to generate one coherent song from both the left and right speakers.

Despite the inferior audio quality of AM broadcasting, many popular audio programs are still broadcast on AM channels. These programs generate significant advertising income for radio stations. Although the prospective markets for these audio programs may be very large, the reception is limited due to the poor penetration of AM audio. Furthermore, in both AM and FM broadcast, the limited availability of radio channels precludes a station from expanding and broadcasting more content in a given day. Therefore, there still is a need for a system capable of broadcasting more audio programs to the limited FM channels.

### INVENTION SUMMARY

This invention provides a system capable of broadcasting at least two distinct audio programs to one FM channel so that a listener may choose between the two distinct audio programs within one FM channel. The system utilizes the left and right channels of stereo FM radio to broadcast two separate audio programs, one on the “Left” channel, and a separate program on the “Right” channel. The FM receiver then receives the Left and Right audio signals and outputs the audio signals to left and right speakers that convert the audio signals to sound. For example, an FM radio channel may broadcast a sports game on the “Left” channel, while broadcasting a talk show commenting on the game on the “Right” channel. The FM radio channel may also broadcast a sports talk show in one channel and music that is distinct from the sports talk show on the other channel. The audio programs on the “Left” and “Right” channels may be related in content, however, portions may be different and not intended to be played simultaneously. The “type” of shows that may be broadcast on the Left and Right channels may vary, such as sports games, talk shows, musical, or any other types of audio programs. The system may also rebroadcast audio programs at a later time so that the morning audio program may be rebroadcast in the evening so that listeners that miss the morning program may hear it in the evening. For example, the “Left” channel of a stereo FM channel may re-broadcast an AM radio program that begins at 7:00 a.m. The “Right” channel of the stereo FM signal may broadcast the same audio program at 7:00 p.m.

The system may also allow a listener to switch the left channel broadcast to be heard on both the left and right speaker of the receiver. Alternatively, the right channel broadcast may be switched to be heard on both the left and right speakers. With certain FM radios with a balance control, the intensity of volume from the left and right speakers may be varied.

The description above and many other features and attendant advantages of the present invention will become apparent from a consideration of the following detailed description when considered in conjunction with the accompanying drawings.

### BRIEF DESCRIPTION OF THE FIGURES

A detailed description with regard to the embodiments in accordance with the present invention will be made with reference to the accompanying drawings.

FIG. 1 illustrates a system diagram capable transmitting two separate audio programs that are FM radio modulated.

FIG. 2 illustrates two distinct audio programs for broadcast on the left and right channels of an FM stereo broadcast.

FIG. 3 illustrates a system diagram that combines two distinct audio programs and modulated on an FM carrier;

FIG. 4a illustrates a switch in a first position coupling two input terminals to two output terminals.

FIG. 4b illustrates the switch of FIG. 4a in a second position coupling the two input terminals to the two output terminals in a different configuration.

FIG. 4c illustrates the switch of FIG. 4a in a third position coupling the two input terminals to the two output terminals in a different configuration.

FIG. 4d illustrates the switch of FIG. 4a in a fourth position coupling the two input terminals to the two output terminals in a different configuration.

FIG. 5 illustrates a switch that sends the output of a left pre-amplifier into the input of a left and a right power amplifier.

FIG. 6 illustrates a switch that sends the output of a right pre-amplifier into the input of a left and a right power amplifier.

FIG. 7 illustrates a switch that sends the output of a left and a right pre-amplifier into the input of a left and a right power amplifier, respectively.

### DETAILED DESCRIPTION OF THE PREFERRED EMBODIMENTS

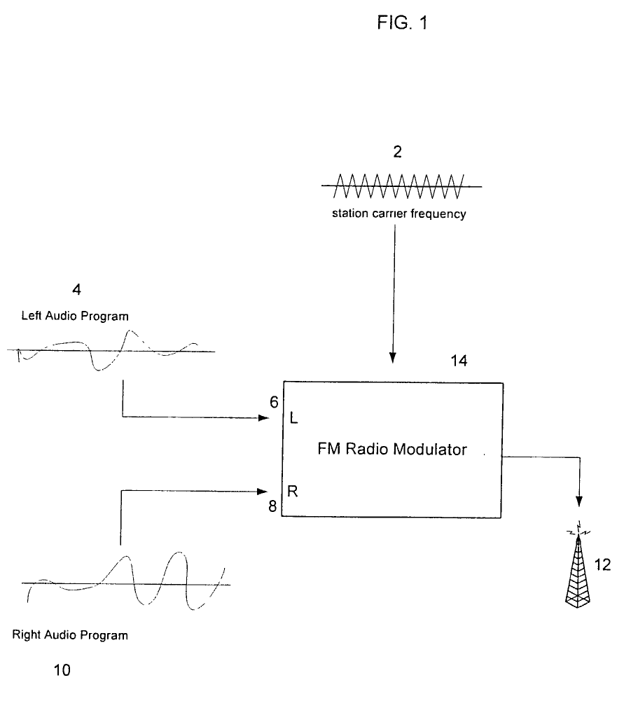

FIG. 1 illustrates a system where two distinct audio programs are modulated for broadcasting in FM signals to a predetermined FM channel. The distinct signals may include a left audio program 4 and a right audio program 10 that are modulated by an FM radio modulator 14. The left 4 and right 10 audio programs may be fed into the left 6 and right 8 inputs of the FM radio modulator 14. A predetermined radio station carrier frequency 2 may also be fed into the FM radio modulator 14, and the left and right audio programs may be modulated onto the carrier frequency 2. The modulated left and right signals 4 and 10 may be broadcasted through a transmitter 12 to FM receivers within a certain area. A listener may tune into the predetermined channel and have an option to listen to either the left audio program 4 through the left speaker or the right audio program 10 through the right speaker. By utilizing separate programs on the left and right channels, a single FM carrier can effectively double its radio broadcast time, revenue, and public services respectively, without increasing FM bandwidth.

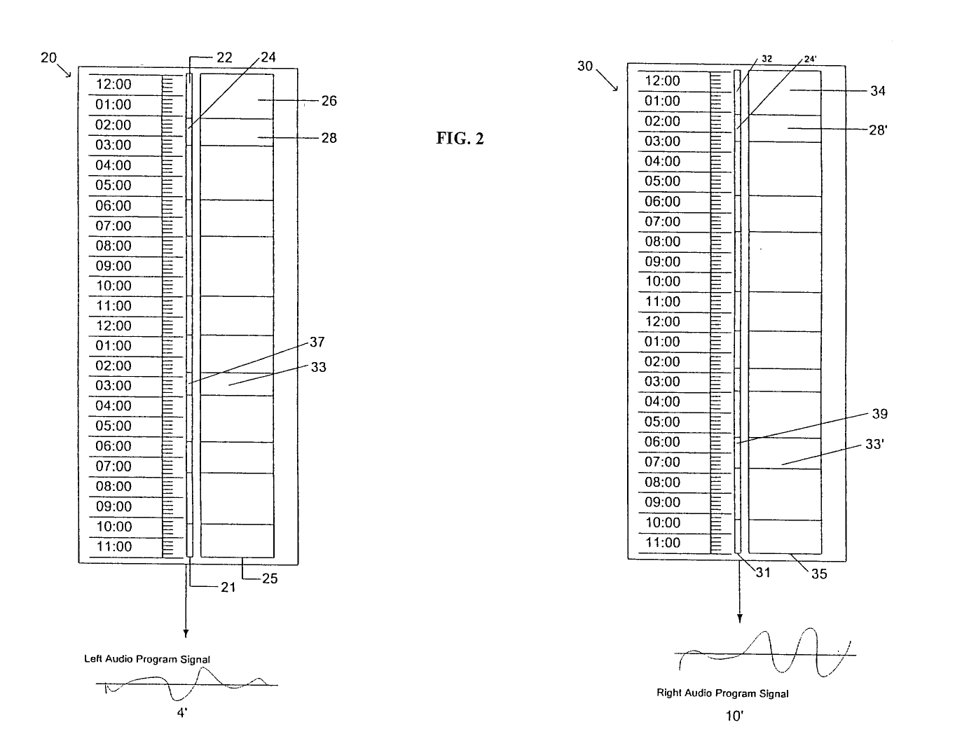

FIG. 2 illustrates two radio programs broadcasting through the left and right channels of an FM stereo transmission. Both the left 20 and right 30 audio programs may include time slots 21 and 31 that define “chunks” of broadcast time in a given day. Sub-programs 25 and 35 may then fill the time slots 21 and 31, to create the radio program. A first radio sub-program 26 may occupy a time slot 22, and a second different radio sub-program 34 may occupy the same time slot 32 on the other audio program. The left and right audio programs 20 and 30 may be converted into audio signals 4′ and 10′ and prepared for FM stereo broadcast.

Alternatively, a sub-program 33 may occupy a time slot 37 on the audio program 20, and the same program 33 may occupy a different time slot 39 on the other radio program. This allows a program to be broadcast at different times in the day. For example, a program may be broadcast at 7:00 a.m., and then re-broadcast at 7:00 p.m. This way, the same program may be re-broadcast at a later time to fit into the schedules of other listeners. Further, additional commercials may be added without losing content and increase revenue by broadcasting on a single FM carrier.

The same program 28 and 28′ may be played at the same time slots 24 and 24′ on the left and right channels, for example, to inform the listener that the current radio station is a two-channel stereo broadcast where different programs are being played on the left and right stereo channels. Still further, the program 28 and 28′ may be played simultaneously on both the left and right channels of an FM stereo transmission.

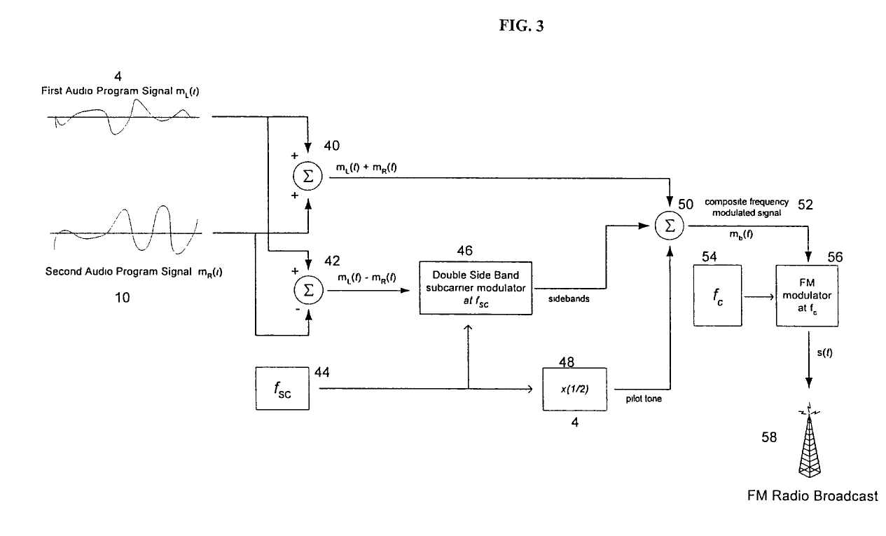

FIG. 3 illustrates a system diagram for modulating and transmitting the left and right audio program signals 4 and 10 to one FM channel. A listener with a conventional monaural FM receiver may hear the monaural audio that includes the left plus the right channel audio. A listener with a stereo receiver may receive the left-channel audio on the left channel speaker(s), and the right channel audio on the right channel speaker(s). The left 4 and right 10 channel audios may be combined 40 to produce a monaural signal (m_{L}(t)+m_{R}(t)), and the difference audio 42 (m_{L}(t)−m_{R}(t)) may be used to modulate 46 a Double Side Band Suppressed Carrier (DSB-SC) signal to form sidebands. The frequency 44 used to DSB-SC modulate the difference signal may be halved 48 to form a pilot tone that may be added 50 to the sum signal and the sidebands to form the composite base band signal m_{b}(t). The pilot tone may provide a reference signal for coherent sub-carrier demodulation in the receiver. The composite frequency modulated signal 52 may be then modulated 56 with the FM channel carrier f_{c}, generated by the frequency channel generator 54, and transmitted 58 to FM receivers within a certain area.

The FM stereo transmission may be received by many types of FM receivers known in the art. A stereo FM receiver having a balance control may allow a listener to switch between the left and right audio channels. The balance control in an FM stereo receiver may also allow a user to isolate either a left program or right program by setting the balance to the left or to the right, respectively.

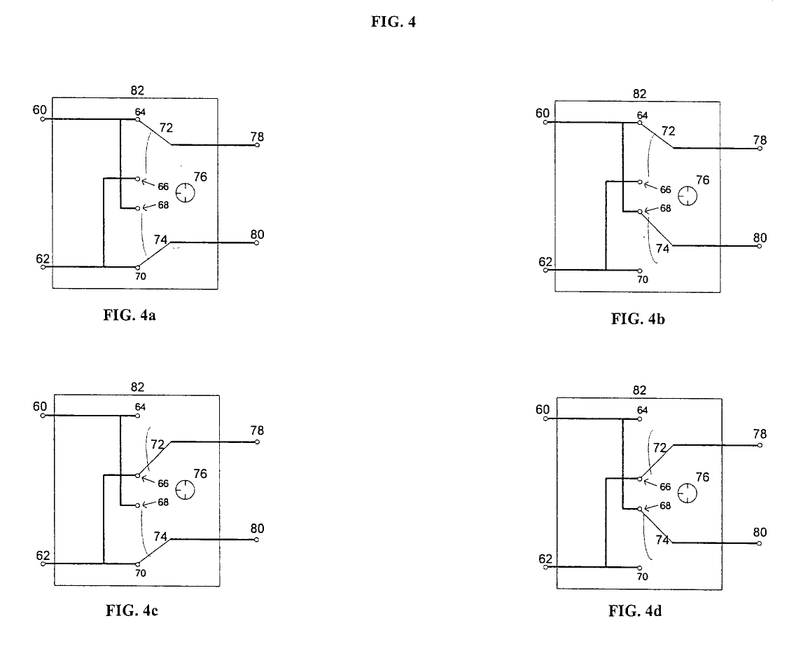

FIGS. 4-7 illustrate receiver switching circuits that may be incorporated into any type of FM stereo receiver such as, but not limited to, a Walkman™, FM receiver component units, car audio receivers, any type of audio device that plays back pre-recorded medium in stereo format; or separate programming for the left and right channel, tape recorders, tape players, CD-Burners, CD-Players, memory chip players such as MP3 and multi-channel digital satellite transmitters and receivers, or any other type of receivers known in the art and developed in the future.

FIGS. 4a through 4b show a switching circuit 82 that include two input terminals 60 and 62, and two output terminals 78 and 80. The input terminals 60 and 62 may be communicatively coupled to the output of the “left” and “right” channel pre-amplifiers of an FM stereo receiver. Alternatively, the input terminals 60 and 62 to the switching circuit may be communicatively coupled to a jack that may be inserted into the headphone receptacle of a stereo FM receiver. Additionally, the switching circuit 82 may be directly integrated into headsets of existing FM portable, home base stereo FM receiving system, and Television Stereo transmissions and receivers including High Definition Television Broadcasting transmitters and receivers. The input terminals 60 and 62 may be also directly integrated into the FM stereo receiver and directly coupled to a left and right channel pre-amplifier. The output terminals 78 and 80 may be communicatively coupled to a left and right input of a power amplifier or directly connected to left and right speakers.

The switching circuit 82 may include a master control 76 to control two internal switches 72 and 74. The master control may have four settings. FIG. 4a shows the master switch 76 in a first setting where the switch 72 may be communicatively coupled to the lead 64 so that the input terminal 60 is coupled to the output terminal 78. In addition, the switch 74 may be communicatively couple to the lead 70 so that the input terminal 62 is coupled to the output terminal 80. Accordingly, two separate signals at the input terminals 60 and 62 may be sent to two separate output terminals 78 and 80, respectively. The first setting of the master switch 76 may allow two independent channels of sound to be played through the “left” and “right” channels of an FM stereo receiver, respectively. The output terminals 78 and 80 may be connected to a left and right channel input of a stereo amplifier and/or left and right speakers.

FIG. 4b illustrates a second setting where the switches 72 and 74 are communicatively coupled so that the input terminal 60 are coupled to the output terminals 78 and 80. In this example, one signal at the input terminal 60 may be sent to two separate output terminals 78 and 80. The configuration in FIG. 4b may allow one independent channel of sound to be played through the “left” and “right” channels of an FM stereo receiver. The output terminals 78 and 80′ may be connected to a left and right channel input of a stereo amplifier and/or left and right speakers. FIG. 4c illustrates a third setting of the control 76 similar to the second setting illustrated in FIG. 4b, with the exception that the input from channel 62 is sent to the output terminals 78 and 80. FIG. 4d illustrates a fourth setting where the master switch 76 couples the input terminal signal 60 to the output terminal 80 and input terminal signal 62 to the output terminal 78, thereby reversing the outputs. The fourth setting may be used for acoustical reasons or enhance the sound for hearing impaired.

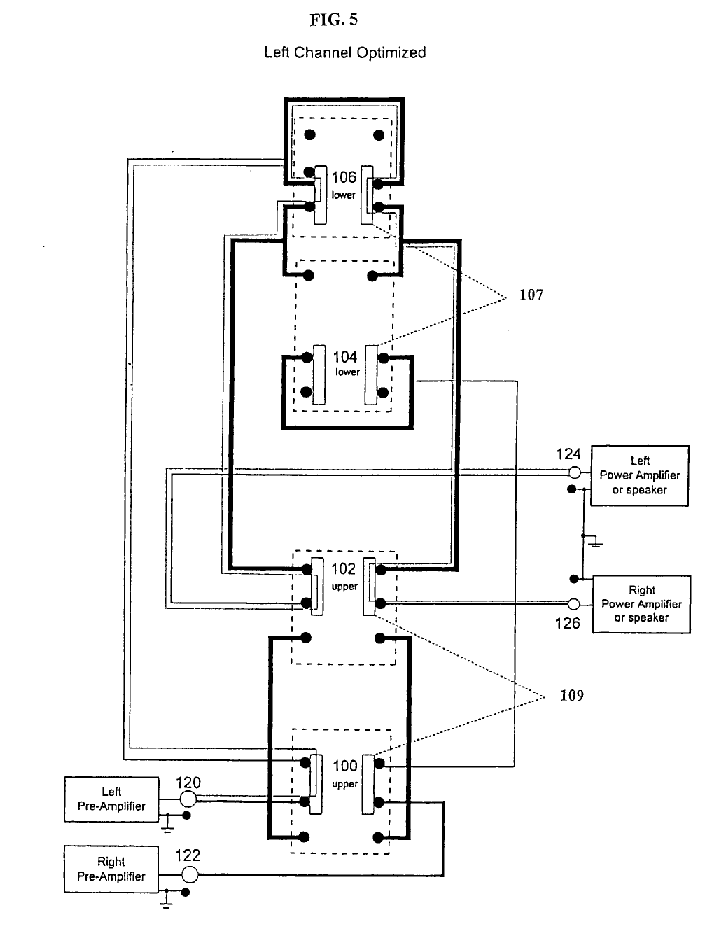

FIG. 5 illustrates an alternative receiver switching circuit that includes four switches 100, 102, 104, and 106, each occupying an “upper” or “lower” position. The switches 100 and 102 may be bridged 107 to toggle simultaneously, and switches 104 and 106 may be bridged 109 to toggle simultaneously as well. This way, the user may have two control buttons or slide switches to choose from. When switch 100 is in its upper position, the switch 102 is in its upper position as well, and both switches 104 and 106 are in their lower position. These switching positions communicatively couple the input terminal 120 with the output terminals 124 and 126. In this configuration, one signal at the input terminal 120 may be sent to two separate output terminals 124 and 126. The configuration in FIG. 5 may allow one independent channel of sound to be played through the “left” and “right” channels of an FM stereo receiver. The output terminals 124 and 126 may be coupled to a left and right channel input of a stereo amplifier and/or left and right speakers. The input terminals 120 and 122 may be communicatively coupled to the output of a “left” and “right” pre-amplifier in an FM stereo receiver.

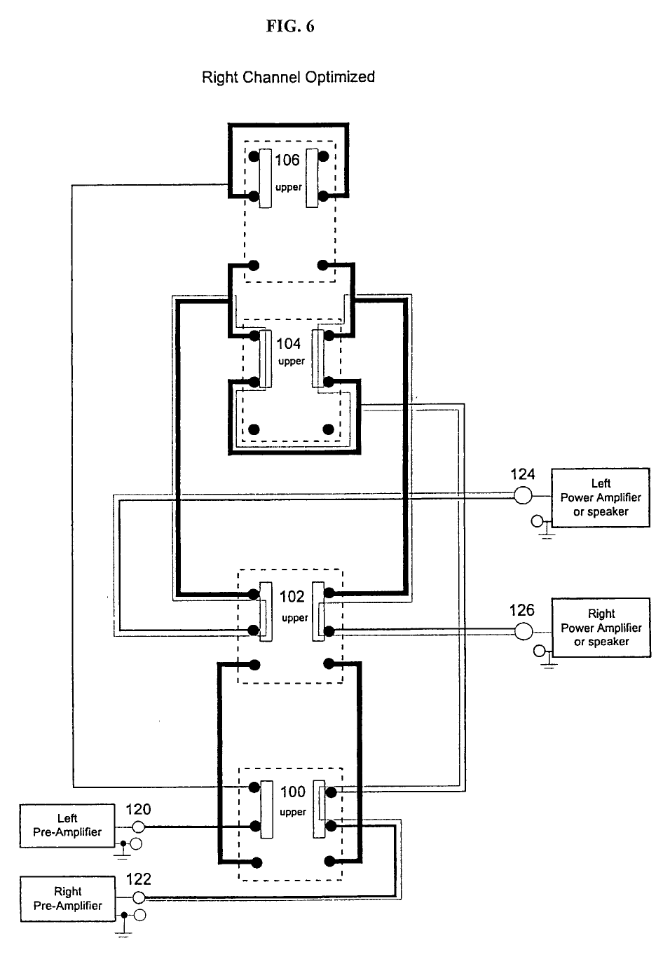

FIG. 6 illustrates the receiver switching circuit in FIG. 5 with the exception that switches 104 and 106 are in their upper positions and the input from channel 122 as opposed to 120 is sent to the output terminals 124 and 126.

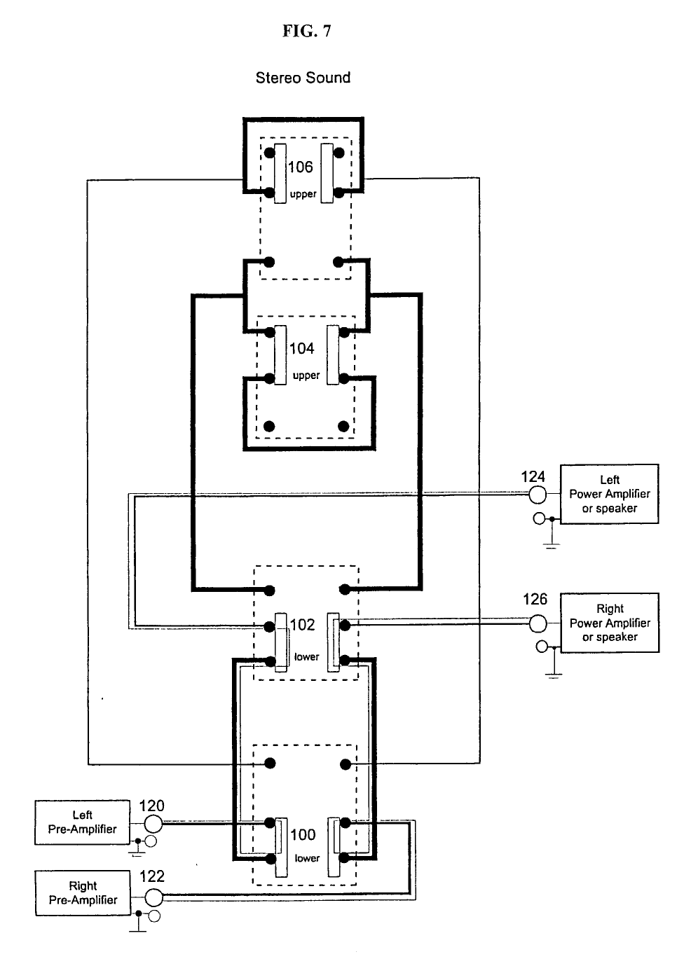

FIG. 7 illustrates the switching circuit in FIGS. 5 and 6 where switches 104 and 106 may be in their “upper” or “lower” position and switches 100 and 102 may be in their “lower” position. In this configuration, the input terminal 120 is communicatively coupled with the output terminal 124, and the input terminal 122 is communicatively coupled to the output terminal 126 so that the two separate signals at the input terminals 120 and 122 may be sent to two separate output terminals 124 and 126, respectively. The configuration in FIG. 7 may allow two independent channels of sound to be played through the “left” and “right” channels of an FM stereo receiver, respectively. The output terminals 124 and 126 may be coupled to a left and right channel input of a stereo amplifier and/or left and right speakers. The input terminals 120 and 122 may be communicatively coupled to the output of a “left” and “right” preamplifier in an FM stereo receiver.

The input terminals 120 and 122 to the switching circuits in FIGS. 5-7 may be communicatively coupled to a jack that can then be inserted into the headphone receptacle of a stereo FM receiver or playback audio device. Alternatively, the input terminals may be directly integrated into the FM stereo receiver and directly coupled to a “left” and “right” channel pre-amplifier.

This invention may apply to all types of switching circuits known to one ordinarily skilled in the art, such as, but not limited to, digital switches, analog switches, software switches, integrated circuit switches, with varying designs and configurations, which may include light and Liquid Crystal Diode word/numeric displays of selection options.

In closing, it is noted that specific illustrative embodiments of the invention have been disclosed hereinabove. However, it is to be understood that the invention is not limited to these specific embodiments. With respect to the claims, it is the applicant's intention that the claims not be interpreted in accordance with the sixth paragraph of 35 U.S.C. §112 unless the term “means” is used followed by a functional statement.

What is claimed is:

1. A method for broadcasting two different audio programs to a frequency modulated (FM) channel, comprising:
broadcasting a first audio program and a second audio program on an FM carrier, where the first audio program is distinct from the second audio program; and
demodulating the FM carrier to produce stereo audio with a left and a right channel where the first audio program is channeled to the left channel and the second audio program is channeled to the right channel.

2. The method according to claim 1 where the broadcasting further includes:
associating the FM carrier with an associated sub-carrier signal;
providing a pilot tone;
adding a first audio signal for the first audio program with a second audio signal for the second audio program to produce an added signal;
modulating the first audio signal minus the second audio signal onto the sub-carrier to produce sidebands;
adding the pilot tone, the sidebands, and the added signal to form a composite signal;
frequency modulating the FM carrier with the composite signal to produce a composite frequency modulated signal; and
transmitting the composite frequency modulated signal.

3. The method according to claim 1, further including:
selecting one of the first and second audio programs to hear that audio program.

4. The method according to claim 1, where the demodulating is done by a FM stereo radio.

5. The method according to claim 1, further including:
connecting the first audio signal and the second audio signal to the left channel and the right channel, respectively.

6. The method according to claim 1, further including:
connecting the first audio signal to the left channel and the right channel, respectively.

7. The method according to claim 1, further including:
connecting the second audio signal to the left channel and the right channel, respectively.

8. The method according to claim 1, further including:
connecting the first audio signal and the second audio signal to the right channel and the left channel, respectively.

9. A method for broadcasting two different audio programs to a frequency modulated (FM) channel, comprising:
providing a main carrier signal with an associated sub-carrier signal;
providing a first audio program signal and a separate second audio program signal;
providing a pilot tone;
adding the first audio program signal plus the second audio program signal to produce an added signal;
modulating the first audio program signal minus the second audio program signal onto the sub-carrier to produce sidebands;
adding the pilot tone, the sidebands, and the added signal to form a composite signal;
frequency modulating the main carrier signal with the composite signal to produce a composite frequency modulated signal; and
transmitting the composite frequency modulated signal.

10. A method for broadcasting two different audio programs to an FM channel, comprising:
providing a first audio program having a first time slot associated with a first program;
providing a second audio program having a second time slot associated with a second program, where the first program is distinct from the second program;
converting the first audio program into a first audio program signal;
converting the second audio program into a second audio program signal; and
transmitting the first and second audio programs through left and right channels of an frequency modulated (FM) channel.

11. The method according to claim 10, further including:
providing a main carrier signal with an associated sub-carrier signal;
providing a pilot tone;
adding the first audio program signal plus the second audio program signal to produce an added signal;
modulating the first audio program signal minus the second audio program signal onto the sub-carrier to produce sidebands;
adding the pilot tone, the sidebands, and the added signal to form a composite signal;
frequency modulating the main carrier signal with the composite signal to produce a composite frequency modulated signal; and
transmitting the composite frequency modulated signal.

12. The method according to claim 10 where the first sub program and the second sub program are identical.

13. The method according to claim 12 where the first time slot and the second time slot are different.

14. A method for broadcasting two different audio programs to an FM channel, comprising:
providing a first audio program having a first sub-program that plays at a predetermined time and a first intermediate program which plays at an intermediate time;
providing a second audio program having a second sub-program, distinct from the first audio program that plays at the predetermined time and a second intermediate program which plays at the intermediate time, where the first and second intermediate programs are substantially identical;
converting the first audio program into a first audio program signal;
converting the second audio program into a second audio program signal;
providing a main carrier signal with an associated sub-carrier signal;
providing a pilot tone;
adding the first audio program signal plus the second audio program signal to produce an added signal;
modulating the first audio program signal minus the second audio program signal onto the sub-carrier to produce sidebands;
adding the pilot tone, the sidebands, and the added signal to form a composite signal;
frequency modulating the main carrier signal with the composite signal to produce a composite frequency modulated signal; and
transmitting the composite frequency modulated signal.

15. An apparatus capable of broadcasting different audio programs to an FM channel, comprising:
a switching circuit having a master switch capable of coupling left and right input terminals to left and right output terminals, where the left and right input terminals are adapted to couple to outputs from left and right channel pre-amplifiers of an FM receiver, respectively, and the left and right output terminals are adapted to left and right speakers, respectively.

16. The apparatus according to claim 15, where the master switch in a first position couples the left and right input terminals to the left and right output terminals, respectively.

17. The apparatus according to claim 15, where the master switch in a second position couples the left input terminal to the left and right output terminals.

18. The apparatus according to claim 15, where the master switch in a third position couples the right input terminal to the left and right output terminals.

19. The apparatus according to claim 15, where the master switch in a fourth position couples the left input terminal to a right output terminal, and couples the right input terminal to the left output terminal.

20. The apparatus according to claim 15 where the switching circuit is a software switching circuit.

21. The apparatus according to claim 15 where the switching circuit is a hardware switching circuit.

22. A method for producing two different audio programs from one FM channel, comprising:
broadcasting a first audio program through a left channel in an FM carrier and a second audio program that is distinct from the first audio program through the FM carrier;
receiving the first and second audio programs in the FM carrier; and
generating the first or second audio program from the FM carrier.

23. The method according to claim 22, where the transmitting includes:
providing a main carrier signal with an associated sub-carrier signal;
adding the first audio program signal plus the second audio program signal to produce an added signal;
modulating the first audio program signal minus the second audio program signal onto the sub-carrier to produce sidebands;
adding a pilot tone, the sidebands, and the added signal to form a composite signal;
frequency modulating the main carrier signal with the composite signal to produce a composite frequency modulated signal; and
transmitting the composite frequency modulated signal.

24. A system for providing two different audio programs from one FM channel, comprising:
a broadcaster transmitting a first audio program and a second audio program through an FM carrier, where the first and second audio programs are distinct from each other; and
a receiver adapted to receive the FM carrier to produce stereo audio with a left channel and a right channel, where the first audio program is channeled to the left channel and the second audio program is channeled to the right channel.

25. The system according to claim 24, further including:
a switching circuit capable of coupling left and right channels of the FM carrier to left and right speakers.

26. The system according to claim 25, where the switching circuit has a master switch that is variable in a number of positions to couple the left and right channels of the FM carrier to the left and right speakers in a variety of configuration.

27. The system according to claim 26, where the master switch in a first position couples the left and right channels to the left and right output terminals, respectively.

28. A system for providing two different audio programs from one FM channel, comprising:
means for broadcasting two distinct audio programs within a certain area;
means for receiving the two distinct audio programs; and
means for selecting between the two distinct audio programs and playing at least one of the two distinct audio programs to a listener.

29. The system according to claim 28, where the means for broadcasting the two distinct audio programs is through an FM carrier.

30. The system according to claim 28, where the means for receiving the two distinct audio programs is a FM radio.

31. The system according to claim 28, where the means for selecting is a switching circuit having a first pair of switches and a second pair of switches, where the first and second pair of switches are capable of moving between upper and lower positions to allow at least one of the two distinct audio programs to be played at at least one of left or right speaker.
